(19) United States
(12) Patent Application Publication
(10) Pub. No.: US 2007/0011296 A1
(43) Pub. Date: Jan. 11, 2007

(54) Online support technique to support elimination of problems arising in device

(75) Inventors: Masumi Yoshino, Nagano-ken (JP); Yoshihiko Akasaka, Nagano-ken (JP); Bruno Ziegler, Levallois-Perret Cedex (FR); Peter Butler, Hertfordshire (GB); Marita Haas, Dusseldorf (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Seiko Epson Corporation, Tokyo (JP)

(21) Appl. No.: 11/507,437

(22) Filed: Aug. 22, 2006

Related U.S. Application Data
(63) Continuation of application No. 09/817,203, filed on Mar. 27, 2001.

(30) Foreign Application Priority Data
Mar. 29, 2000 (JP) 2000-090785
Feb. 27, 2001 (JP) 2001-051460

(51) Int. Cl. G06F 15/173

(52) U.S. Cl. 709/223

(57) ABSTRACT

The online support system of the present invention provides each user with possible resolutions and operations to eliminate problems and troubles arising in a device of the user in the form of Web pages. The online support system allows the user to gain access to a Web page defined by the URL, which is specified according to user's input information, for example, the model name of the device, the nation, the operating system, and the type of a problem. Possible resolutions and operations against a specific problem, which are prepared in advance, are then displayed for self help on the browser. The operations and resolutions are provided in a stepwise manner in response to user's instructions until the problem is eliminated. When the problem is not eliminated by any of the possible operations and resolutions, the online support system displays an E mail (electronic mail) transmission form. The transmission form allows the user to gain E mail support. The user inputs regular pieces of information generally required for the support and arbitrary pieces of information with regard to the specific problem in the transmission form. Data processed by the device and a browsing log of the possible operations and resolutions against the specific problem are also added to such information. This online support system enables the user to effectively use both self support by the possible resolutions and operations prepared in advance and the E mail support, thus efficiently eliminating the problem arising in the device of the user.

### CROSS-REFERENCE TO RELATED APPLICATIONS

This continuation application is based upon and claims the benefit of priority under 35 U.S.C. §120 from U.S. application Ser. No. 09/817,203, filed Mar. 27, 2001, the entire contents of which is hereby incorporated by reference in its entirety. This continuation application also claims the benefit of priority under 35 U.S.C. §119 from Japanese Patent Application Nos. 2000-090785, filed on Mar. 29, 2000, and 2001-051460, filed on Feb. 27, 2001.

### BACKGROUND OF THE INVENTION

1. Field of the Invention

The present invention relates to an online support technique that gives online support to eliminate problems and troubles arising in a device.

2. Description of the Related Art

The online support via the Internet becomes a common technique to support users who require elimination of a variety of troubles and problems arising in a diversity of devices including printers and scanners. One method of the online support utilizes electronic mails. When a problem arises in a device, the user transmits an electronic mail describing the details of the problem to an online support center managed by, for example, the manufacturer of the device. The online support center analyzes the cause of the problem based on the information written in the electronic mail and suggests the user a possible operation.

Another method of the online support provides support information for eliminating the problem, that is, online help, in the form of Web pages on the Internet. In general, possible operations and resolutions against common troubles and problems and those readily eliminated by the user are provided in the Web pages managed by the manufacturer of the device. The user simply refers to the support information according to the model of the device and the type of the problem, in order to eliminate the problem.

The problems and troubles arising in the device often have a common cause. In many cases, these problems and troubles are ascribed to the carelessness of the users and are readily eliminated. The E mail support is, however, required to individually respond to the similar questions of the users. This undesirably increases the loading on the E mail support and interferes with the quick response to the significant problems and troubles that can not be eliminated readily by the user.

As described above, the possible operations and resolutions are provided against the troubles and problems readily eliminated by the user as the support information. In the prior art online support, however, such support information is not sufficiently utilized.

The user generally can not give a sufficient description with regard to the working status of the device and the problem arising in the device. Such users do not give the sufficient information required to elucidate the cause of the problem in the E mail support. Namely it is difficult for such users to gain the efficient E mail support. The users who can not sufficiently describe the problem generally can not solve even an easy problem by the self efforts. This accordingly enhances the loading on the E mail support.

### SUMMARY OF THE INVENTION

The object of the present invention is thus to provide an online support technique that relieves loading on E mail support, which supports normal operations of a device by utilizing electronic mails. The object is also to provide a technique that facilitates elucidation of the cause of a problem arising in a device in the course of online support.

At least part of the above and the other related objects is attained by one online support method that gives online support to eliminate a problem arising in a device. The first online support method includes the steps of: (a) providing a user of the device with a specific form that enables the user to input and transmit information with regard to the problem; and (b) providing the user of the device with support information, which is prepared in advance for elimination of the problem, prior to the step (a).

Here the problem represents any abnormal working status of the device and does not always mean a failure. For example, when one of expendables required for the normal operation of the device is completely used up, the device does not work normally. The problem in the specification hereof includes such a status.

The step (a) may be actualized by a process of providing the specific transmission form, for example, an E mail transmission form, in a Web page. The step (a) may alternatively be actualized by a process of activating an application program for electronic mails installed in a client. In the former process, it is preferable to provide the transmission form on the browser, for example, by the technique of CGI (common gateway interface). The transmission form may be provided as a template of a predetermined application program, instead of the electronic mail. When the support information is provided in the Web page, the Web page may include an area that allows pieces of information with regard to the problem to be written. The step (b) may be actualized by a process of displaying the support information on the browser or by a process of transmitting a file with the support information recorded therein to the client.

The first online support method of the present invention provides the user with support information prepared in advance, prior to the support utilizing the specific form, such as an E mail transmission form (hereinafter referred to as the mail support). This method provides the support information and the mail support in a sequence and thus enables the user to try the self support based on the support information, prior to asking for the mail support. This enhances the chance of the user's self support when the problem arises in the device and thereby lowers the requirement for the mail support. This effectively relieves the loading on the mail support in the online support system. The relieved loading on the mail support ensures the marginal capacity of the mail support and thus improves the quality of the online support. This arrangement also enables the user to readily eliminate the problem without waiting for the response of the mail support, thus enhancing the convenience of the device.

The first online support method of the present invention is characterized by the sequenced link of the self support with support information prepared in advance to the mail support. This arrangement enhances the use of the support information, which has not been used effectively in the prior art technique, and relives the loading on the mail support, thus improving the quality of the online support. This arrangement thus enables the advantages of the self support with the support information to be compatible with the advantages of the mail support.

In the first online support method of the present invention, the support information prepared in advance may be provided in a variety of forms. For example, possible resolutions and operations are provided in the form of a list according to the device and the problem. In another example, the support information may be provided in response to each selecting instruction given by the user. The latter example corresponds to an application of providing the support information in an interactive manner. In the latter application, when the user specifies the device and the problem, one typical operation or resolution is given to the user. In the case where the given operation or resolution can not eliminate the problem, another operation or resolution is given to the user in response to the user's requirement. In this manner, possible operations and resolutions are provided sequentially. This arrangement enables the user to try the operations and resolution one by one for elimination of the problem. The sequence of the support information provided in response to the user's requirements may be, for example, an order of easiness of the execution of operations and resolutions or an order of the frequency of occurrence of the causes.

In the online support method of the present invention, the specific form may be any form that allows transmission of information with regard to the problem arising in the device. In accordance with one preferable application, the specific form includes a first part that asks the user to input specific information, which is generally required for analysis of the problem, and a second part that enables the user to input arbitrary information with regard to the problem. In many cases, rather fixed pieces of information are required for efficient analysis of the problem. In the specific form of this arrangement, the first part gives the typical pieces of information to enhance the efficiency of analysis of the problem. The second part gives the detailed information on the problem that can not be covered by the typical information. This arrangement enables the analysis of the problem and the examination of the effective operation to be carried out more flexibly.

In accordance with one preferable application of the present invention, the first online support method further includes the step of: (c) obtaining browsing record information, which represents a user's browsing record of the support information, in addition to the information input in, the specific form.

In the process of mail support, the browsing record allows estimation of the operations that the user has tried, thus enabling the analysis of the problem and the examination of the effective operation to be carried out more appropriately and more efficiently. When the browsing record information is stored in the client, the browsing recording information may be added automatically or in response to a user's operation to the E mail sending the information with regard to the problem. Another application transmits only the address of the browsing record information with the specific form to the online support system, which then gains an online access to the browsing record information. Still another application causes the online support system to store the browsing record information of the Web page.

In the first online support method of the present invention, the specific form for the mail support may be provided only after the support information. Alternatively the method may provide the specific form in response to a user's instruction without providing the support information. In the course of mail support, transmission of plural mails between the user and the online support system may be required before the problem is eliminated. The arrangement of providing the specific form without the support information relieves the labor of the user in the process of transmitting plural mails to and from the online support system.

From this point of view, one preferable embodiment uses a transmission form of a different format in the latter case of online support without the support information, from the format of the transmission form provided in the former case of online support with the support information. For example, the transmission form without the support information may ask the user to attach the resolutions and operations suggested in a previous access for the online support. Another preferable embodiment asks the user to omit input into items in the typical information of the first part that have already been input in a previous access for the online support.

The present invention is also directed to another online support method that gives online support to eliminate a problem arising in a device. This second online support method includes the step of: providing a user of the device with a specific form that enables the user to input and transmit information with regard to the problem, wherein the specific form includes a first part that asks the user to input specific information, which is generally required for analysis of the problem, and a second part that enables the user to input arbitrary information with regard to the problem. The difference from the first online support method is that the second online support method does not provide the user of the device with support information prepared in advance. The use of the specific form exerts the similar effects to those discussed above with regard to the first online support method. The arrangement of using the specific form enables the online support system to more readily grasp the problem arising in the device and offer more appropriate support information. Namely this arrangement effectively relieves the loading on the online support.

Either of the first online support method and the second online support method is applicable to support normal operations of a diversity of devices. In the case where the device carries out either processing or generation of digital data, it is preferable that the specific form asks the user to input at least information that is required to specify a result of the processing or the generation carried out by the device. In one example, when the device inputs either image data or audio data, the information is either the image data or the audio data input into the device. In another example, when the device outputs either an image or audio based on digital data, the information is electronic data representing either the image or the audio output by the device.

Typical examples of the device that carries out either processing or generation of digital data include printers that process data generated by an application program and thereby generate print data, scanners that generate image data, digital cameras, copying machines, and facsimiles. Other examples include devices that record music and other sound in various compression forms like MP3, devices that process audio data, devices that generate video data in various compression forms like MPEG, and devices that edit such video data. The information required to specify the result of the processing or the generation may be data directly representing the result of the processing or generation or information required to gain an online access to such data. For example, in the case of the printer, the data directly representing the result of the processing or generation includes print data generated by the printer driver and electronic data of printed images read, for example, by a scanner. In the case of the scanner and the digital camera that generate image data, the data directly representing the result of the processing or generation includes image data stored in the main body of the device or in a computer used in combination with the device.

In either of the first online support method and the second online support method, the information to be input in the specific form includes first information required to identify the device and second information required to specify a working status of the device.

The first information required to identify the device includes at least one of a model name of the device, an ID number allocated to the individual device, information that identifies a driver program for driving the device, and information that identifies an operating system on which the driver program runs.

The second information required to specify the working status of the device includes at least one of information that identifies an application program activated on the device when the problem arises, information that identifies an application program used for driving the device and specifies data transmitted to the device, and information that specifies a communication environment of the device.

The information that identifies the application program activated on the device when the problem arises includes information with regard to the names and the number of application programs activated. Such information is required to analyze the marginal capacity of the memory resource when the problem arises in the device. The information that identifies the application program used for driving the device and specifies the data transmitted to the device includes information with regard to the unprocessed data file transmitted to the device when the problem arises in the device and the name of the application program used to generate such data. Such information is required to check the data transmitted to the device for any abnormality. The information that specifies the communication environment of the device includes information for specifying the type of the communication port adopted, for example, a parallel port or an USB (universal serial bus). Such information is required to find the cause of the problem attributed to the interface.

In the case where the device includes a storage unit in which specific information representing the working status of the device is stored, the second information required to specify the working status of the device may be information that allows an access to the storage unit. Some devices have a database with regard to the working status called MIB (management information base). The online access to the MIB gives information regarding the working status of the device. In such cases, the second information required to specify the working status of the device is information used to gain an access to the MIB, for example, URI (uniform resource indicator) or another piece of information showing the address of the MIB. The storage unit may be incorporated in a computer connecting with the device, instead of being incorporated in the device itself.

The information may further include pieces of information with regard to the user, for example, the name, address, nation, and language of the user.

The information may also include pieces of information with regard to the operations which the user has tried to eliminate the problem. As described above, the information may further include the browsing record information representing a browsing record of support information. One preferable embodiment provides the user with a list of support information and asks the user to check the operations which the user has tried in the list and transmit the checked list.

The technique of the present invention is attained by a variety of applications, other than the online support method discussed above. For example, the technique of the present invention is actualized by an online support system that gives information to a client and thereby carries out online support to eliminate a problem arising in a device of the client. The online support system is constructed, for example, as a server that is connected to a network to provide the information discussed above. The technique of the present invention is also actualized by a client that gains online support from a predetermined support server to eliminate a problem arising in a device of the client. Here the client is not restricted to an apparatus including the device where the problem arises, but represents any apparatus that the user utilizes to gain the online support. The client may be a workstation or a personal computer in a client/server environment, which stores various data required to eliminate the problem and allows transmission of electronic mails with the various data attached thereto. The attach data are, for example, at least part of a browsing record of support information provided by the server, information for specifying the results of the processing by the device, image data and audio data input into the device, electronic data representing images and audio output from the device, and address data required for the server to access such data.

The technique of the present invention may also be attained by a program for driving a device or another suitable program, which has a function of causing a link to an upper-layered online support Web page, which does not depend upon a model of the device nor a problem, out of support Web pages that provide a client with support information to eliminate a problem arising in the device, to be shown in at least one of a setting window that allows a user of the device to specify settings of the device and a display window that displays a working status of the device. The present invention is also directed to any of programs for attaining the steps of the online support method, the functions of the online support system, or the functions of the client discussed above. The present invention is also actualized by a signal form equivalent to any of such programs and a recording medium in which any of such programs is recorded. Typical examples of the recording medium include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

These and other objects, features, aspects, and advantages of the present invention will become more apparent from the following detailed description of the preferred embodiment with the accompanying drawings.

### BRIEF DESCRIPTION OF THE DRAWINGS

FIG. 1 shows one configuration of an online support system that supports normal operations of printers;

FIG. 2 is a flowchart showing a procedure of utilizing online support;

FIG. 3 shows a display of a setting window PP provided by a printer driver, which includes a link to the online support;

FIG. 4 shows another window display including the link as a first modified example;

FIG. 5 shows still another window display including the link as a second modified example;

FIG. 6 shows a sequential change of windows in the online support;

FIG. 7 shows an example of support information;

FIG. 8 shows a window display when a problem is not eliminated by any of possible operations prepared in advance as support information;

FIG. 9 shows a window display providing the support information as a modified example;

FIG. 10 shows a transmission form as an example;

FIG. 10A shows another exemplary transmission form; and

FIG. 11 shows the configuration of another online support system in one modified example.

### DESCRIPTION OF THE PREFERRED EMBODIMENTS

The technique of the present invention is, for example, applicable to online support that supports normal operations of printers. This is explained below in the following sequence as one preferable mode of carrying out the invention:

A. Configuration of System

B. Online Support

B1. Link to Online Support

B2. Sequential Change of Windows in Online Support

B3. E mail Support

C. Modifications

A. Configuration of System

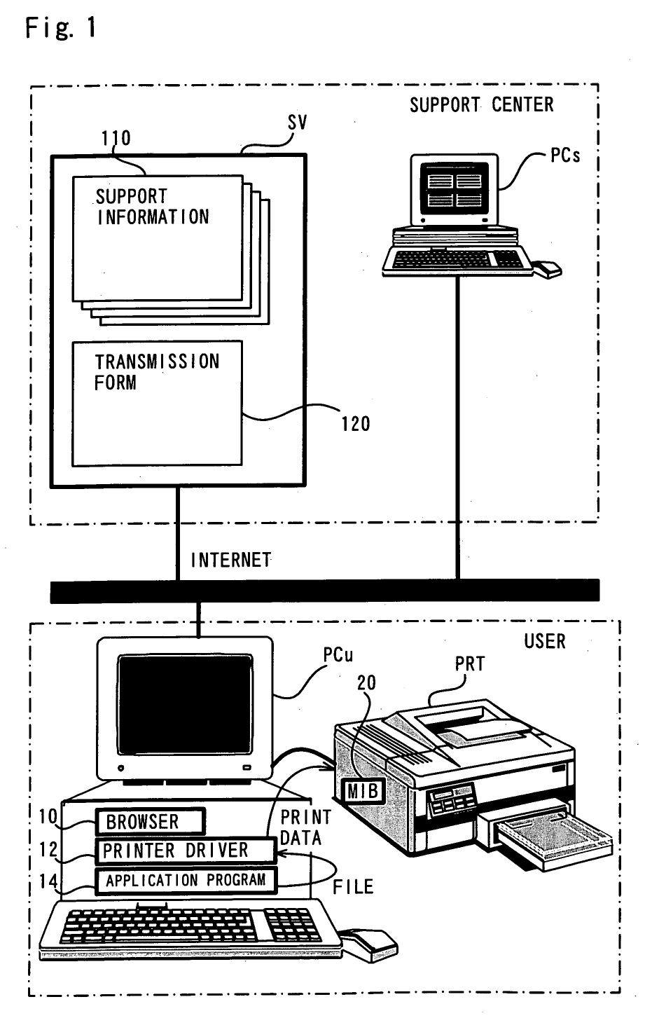

FIG. 1 shows one configuration of an online support system that supports normal operations of printers. The upper portion of the drawing shows the configuration of a system that gives online support of printers, whereas the lower portion of the drawing shows the configuration of a printer user's system that receives the online support. Any organization, party, or individual may provide the online support of printers. In this embodiment, for convenience of explanation, it is assumed that the printers' manufacturer gives the online support at the site called a support center.

The configuration of the printer user's system includes a page printer PRT connected to a computer PCu via a parallel cable. Although the page printer is used as the printer PRT in this embodiment, the target of the online support may be any of various printers, for example, an ink jet printer. Although the printer PRT is locally connected to the printer PCu via the parallel cable, the printer PRT may be connected to the computer PCu via a LAN (Local Area Network).

A plurality of programs working on a preset operating system are installed in the computer PCu. Here a browser 10 that is used to browse Web pages, a printer driver 12 that has functions to drive the printer PRT, and an application program 14 that generates document data and image data to be printed by the printer PRT. In a typical printing process, the application program 14 transfers a print command and a file to be printed to the printer driver 12. The printer driver 12 causes the input file to be subjected to rendering and other required processing and generates print data to be transmitted to the printer PRT. The printer PRT receives the print data via the parallel cable and carries out an actual printing operation. The printer PRT has an MIB 20, which is a database storing a working status of the printer PRT. The user gains access to the MIB 20 via the computer PCu, so as to obtain information with regard to settings of the working status and problems in the printer PRT.

The computer PCu is connected to the Internet. When some trouble or problem arises in the printer PRT, the user of the printer PRT gains mainly two types of online support via the Internet. The first online support utilizes Web pages to notify various pieces of support information. Typical operations and resolutions of frequently arising problems and troubles are provided in the Web pages as support information. The user adopts the browser 10 to gain access to the Web pages defined by a specified URL (uniform resource locator) and browse the support information in the Web pages, in order to attain self support with regard to the problem or the trouble.

The second online support utilizes electronic mails (hereinafter this type of online support is called the E mail support). The user inputs required pieces of information with regard to the problem or trouble in a predetermined transmission form and transmits the input information to the support center. The support center finds the possible cause of the problem or trouble, based on the transmitted information, and sends back the user an electronic mail describing a possible operation or resolution to eliminate the problem or trouble.

The support center providing such online support has the system of the following configuration. The support center includes a server SV that provides users with the support information written in the Web pages and the predetermined transmission form for the E mail support, and a computer PCs that actually carries out the E mail support. The server SV stores support information 110 displayed in the Web pages and data required for providing a transmission form 120 for the E mail support. In the structure of the embodiment, the support information 110 and the transmission form 120 are stored in the form of Web programs using CGI (common gateway interface). The support information 110 and the transmission form 120 may alternatively be stored in another form using HTML (hyper text markup language), Java (registered trademark), or Java Script (registered trademark). Although the support center of this embodiment uses includes the server and the computer, the support center may include only one server or a plurality of servers.

B. Online Support

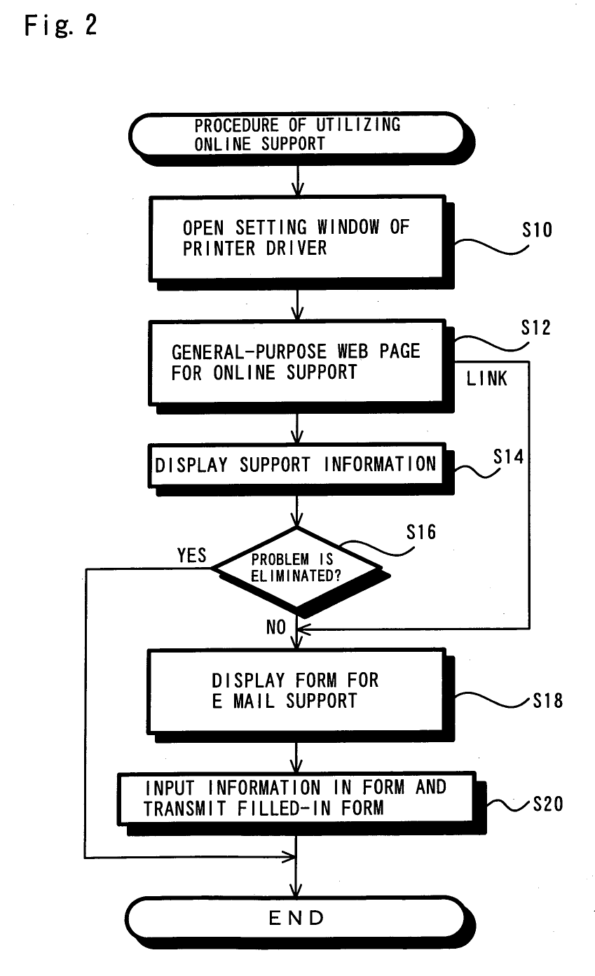

FIG. 2 is a flowchart showing a procedure of utilizing the online support. The procedure shown in FIG. 2 describes a flow of processes mainly from the user's side. The support center carries out a series of processing according to this procedure. From this point of view, the flowchart of FIG. 2 may partly be regarded as a process chart showing the series of processing executed by the support center.

The user opens a setting window of the printer driver 12 at step S110 and gains access to an online support general-purpose Web page, which is provided by the server SV on the Internet, via a link shown in the setting window to receive the online support at step S12. The online support has two different stages. In the first stage, the user browses the support information provided by the server SV, in order to eliminate the problem or the trouble by the user's own efforts (steps S14 and S16). In the second stage, the user sends an electronic mail to eliminate the problem or the trouble (steps S18 and S20). The first stage is called self support, and the second stage is called E mail support. The user obtains the E mail support by causing a predetermined transmission form to be displayed on the screen of the computer PCu at step S18, and inputting required pieces of information in the predetermined form and transmitting the filled-in form to the support center at step S20. In the arrangement of the embodiment, the user gains the E mail support in principle when the user can not eliminate the trouble or the problem (step S16) by browsing the support information (step S14). In the course of E mail support, the user may send and receive a plurality of E mails to and from the support center. For convenience of the user in such cases, there is a link to directly gain the E mail support on the general-purpose Web page without displaying the support information (step S14). The respective procedures are described in detail below.

B1. Link to Online Support

As described above, the user who desires to receive the online support first causes the computer PCu to display the setting window of the printer 12, in order to gain access to the Web site for the online support (step S10 in the flowchart of FIG. 2). In the arrangement of the embodiment, the printer driver 12 has the function of causing the link to the online support to be displayed in the setting window. The link is displayed in the following manner.

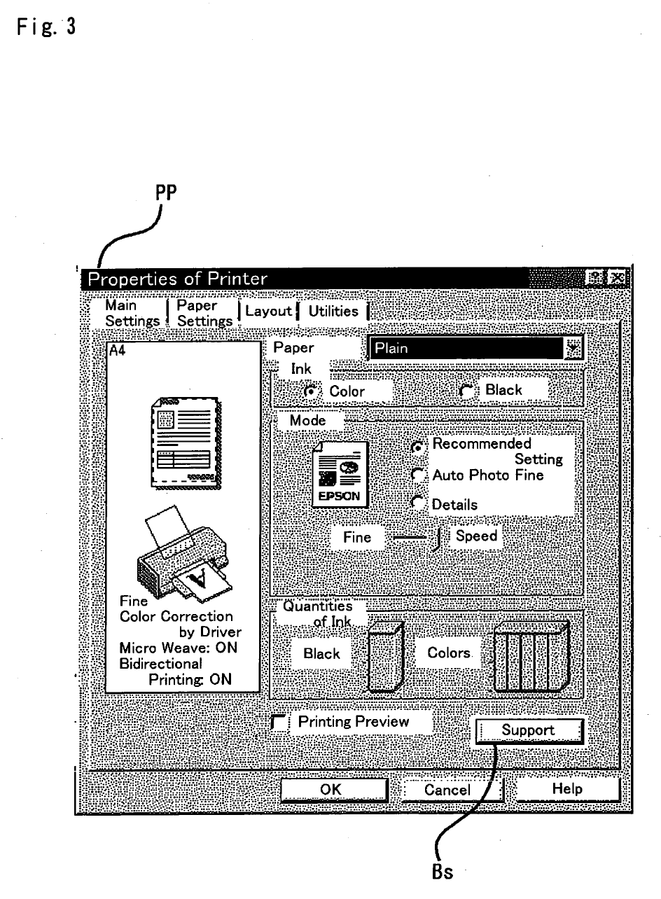

FIG. 3 shows a display of a setting window PP provided by the printer driver 12, which includes a link to the online support. The setting window PP is open when the user selects Printer Properties in a dialog box displayed on the screen of the computer PCu in response to a user's printing instruction. Displaying the setting window PP is one of the functions attained by the printer driver 12. The user specifies various settings, for example, paper used for printing and a print mode in the setting window PP. In the arrangement of the embodiment, a Support button Bs is also included in the setting window PP. The Support button Bs corresponds to the link to the online support at step S10 in the flowchart of FIG. 2. The printer driver 12 stores the URL of the Web page, which is to be accessed for the online support, corresponding to the Support button Bs. The user clicks the Support button Bs with a pointing device, such as a mouse, to gain access to the general-purpose Web page for the online support.

In the arrangement of the embodiment, the user first accesses the general-purpose Web page, which does not depend upon the printer model, the nation, or the language, in the process of online support as discussed later. This arrangement advantageously enables a common module with regard to the function of displaying the Support Button Bs to be used for any printer models, and thereby facilitates the manufacture of the printer driver 12. This arrangement also restricts the Web page that the user accesses first to a single general-purpose Web page, thus advantageously enabling the lower layer in the hierarchical structure to be flexibly changed. For example, such restriction allows a change from one page configuration that carries out classification according to the printer model in the first layer of the hierarchical structure and classification according to the type of problem or trouble in the lower, second layer of the hierarchical structure, to another page configuration that carries out classification according to the type of problem or trouble in the first layer of the hierarchical structure. The restriction of the Web page that the user accesses first enables flexible change of the page configuration without affecting the services of the online support. However, instead of the first link to the general-purpose web page, the link may bring directly a user to the online support related to his printer model inputted beforehand.

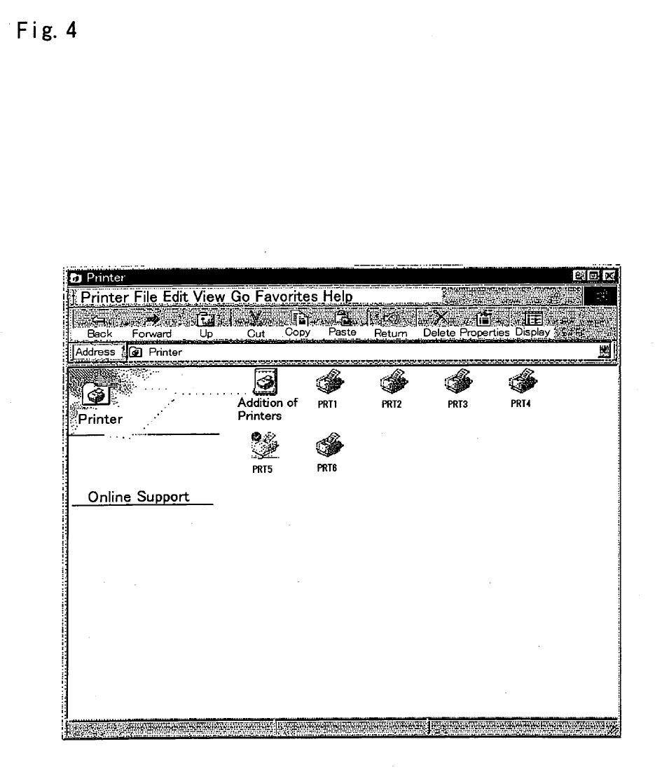

In the arrangement of the embodiment, the link to the online support is displayed in the setting window PP of the printer PRT. The display of the link is, however, not restricted to this application. FIG. 4 shows another window display including the link as a first modified example. This window is used to set printer ports and add and manage available printers in the computer PCu. In this first modified example, the link to the online support is shown in this window as an underlined Online Support option. The user clicks the underlined Online Support option to gain access to the general-purpose Web page for the online support. The link to the online support may be provided in a driver folder that is generated when each printer driver is installed in the computer PCu. In this case, the display format of FIG. 4 may be adopted.

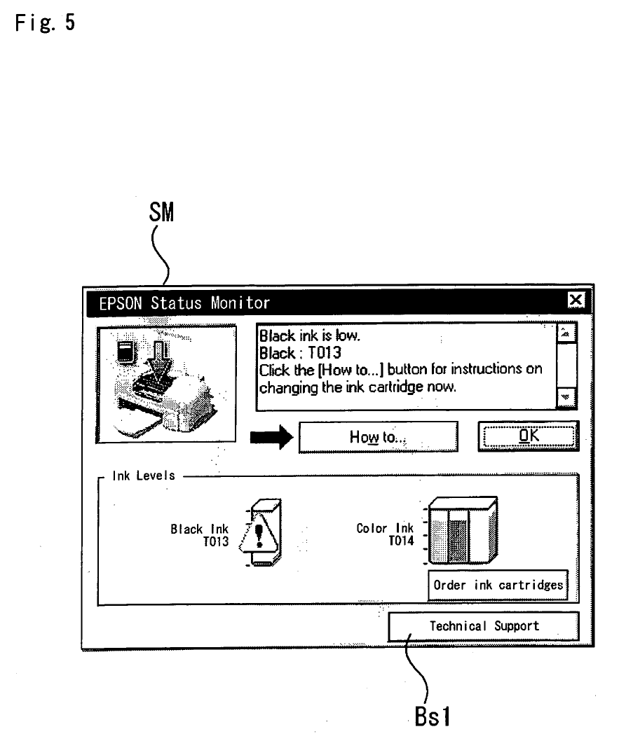

FIG. 5 shows still another window display including the link as a second modified example. In a status monitor of the computer PCu, a window SM shows the working status of the printer, such as the remaining quantities of inks. In this second modified example, the link to the online support is shown in this window SM as a Technical Support button Bs1. The user clicks the Technical Support button Bs1 to gain access to the general-purpose Web page for the online support.

In the embodiment and its modified examples discussed above, the link to the online support is shown in the setting window of the printer or another suitable window. This enhances the convenience of the access to the Web page for the online support. Another procedure directly specifies the URL allocated to the Web page for the online support on the browser for the access.

B2. Sequential Change of Windows in Online Support

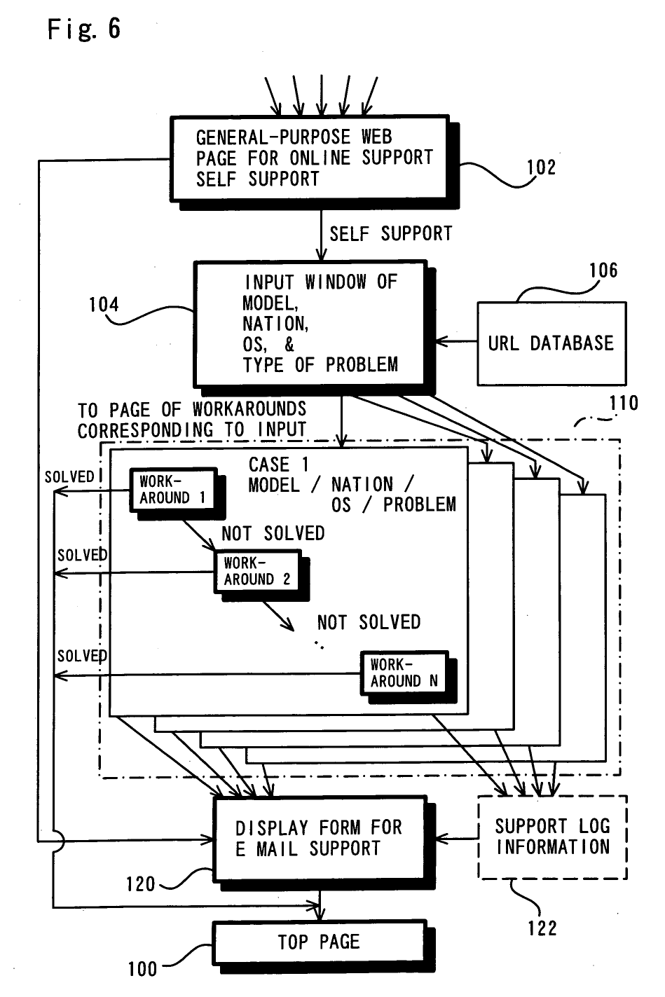

The following describes a sequential change of windows after the user gains access to the general-purpose Web page of the online support via any of the above links. FIG. 6 shows a sequential change of windows in the online support. Data in each page are transmitted from the server SV of the support center and are written in a Web language, for example, HTML. The Web pages that require the user to input information are provided by utilizing the CGI. The sequential change of windows shown in FIG. 6 corresponds to the data structure of the Web page stored in the server SV and represents the procedures of the online support executed by the server SV.

The online support first displays a general-purpose Web page 102. The users of various models, various nations, and various languages access the single general-purpose Web page 102. The general-purpose Web page 102 shows a diversity of links, for example, a link to self support and a link to E mail support.

When the user clicks the link to the self support, the displays changes to an input window 104 for specifying the individual state. The user inputs the model name of the printer, the nation where the printer is located, the operating system, and the type of the problem in the input window 104. In the structure of the embodiment, the user chooses an appropriate option among preset options with regard to each item. For example, the model names of the printers that are subject to the online support are displayed in the form of a dropdown menu, and the user chooses the model name of the own printer in the dropdown menu. The other pieces of information are input in a similar manner. The input of such information may, however, not be restricted to this application, but the user arbitrarily inputs such information, instead of the selection out of the preset options.

The URL of a Web page mapped to the problem is specified by referring to a URL database 106 stored in advance in the server SV based on the input information. Support information 110 specified by the URL is displayed in the Web page. The support information includes operations and resolutions to eliminate the problem. In the arrangement of this embodiment, the URL is specified by a hierarchical structure of ‘model/nation/operating system/type of problem’. For example, when the model name of the printer is LP9000, the nation is JAPAN (expressed by a code JPN), and the operating system is Windows98 (registered trademark; expressed by a code Win98), the URL is specified as ‘JP9000/JPN/Win98/ . . . ’ using the coded data. The hierarchical structure has the advantage of relatively readily specifying the URL. In the case where the URL of the support information corresponding to the problem input in the input window 104 is unequivocally specified in the URL database 106, such a hierarchical structure may not be required. In the structure of the embodiment, the support information 110 is stored in the server SV that provides the general-purpose Web page 102. The support information may alternatively be stored in an external server. For example, the support information 110 may be offered by a server provided for each nation, based on the information with regard to the nation input in the input window 104.

The support information is displayed stepwise in an interactive manner in response to requirements of the user. The procedure first provides the user with a first operation information (Workaround 1) to eliminate the problem. When the user's input shows that the problem is eliminated by Workaround 1, the online support is terminated and the display is returned to a top page 100. When the user's input shows that the problem is not eliminated by Workaround 1, on the other hand, the procedure provides the user with a second operation (Workaround 2). When the problem is eliminated by Workaround 2, the display is returned to the top page 100. When the problem is not eliminated by Workaround 2, on the other hand, the procedure successively provides the user possible operations stored in advance. The content of the online self-help support information may be updated for user's satisfaction.

As shown in FIG. 6, in the arrangement of the embodiment, the user's browsing record of the support information is accumulated as support log information 122. The support log information 122 stores the URLs of the Web pages browsed by the user in a time series. In the structure of the embodiment, the support log information 122 is stored in the user's computer PCu. In the illustration of FIG. 6, the support log information 122 is shown by the broken line, for the purpose of discrimination from the information stored in the server SV The input window 104 and the support information 110 shown in FIG. 6 correspond to the process of self support (steps S14 and S16) shown in the flowchart of FIG. 2. The support log information 122 may be stored together with the information for specifying the user who gained the access, for example, the IP address and MAC address of the user, in the server SV or the support center's computer PCs.

B3. E Mail Support

In some cases, the problem is not eliminated even when the user tries all the possible operations the resolutions stored in advance as the support information. In such cases, a link to the E mail support is shown in the window that provides a last possible operation N. When the user clicks this link, a transmission form 120 is displayed to transmit pieces of information with regard to the problem to the E mail support. The user inputs required pieces of information in the transmission form 120 and transmits the filled-in form to the support center. This terminates the online support and the display is returned to the top page 100. In the procedure of the embodiment, the support log information 122 representing the browsing record of the support information is attached to the information input in the transmission form 120. The E mail support may be carried out without the attachment of the support log information 122. The attachment of the support log information, however, advantageously narrows the range of possible causes of the problem and thus efficiently analyzes the cause of the problem. In the case where the user clicks a link to the E mail support in the general-purpose Web page 102, the transmission form 120 is also displayed for the E mail support.

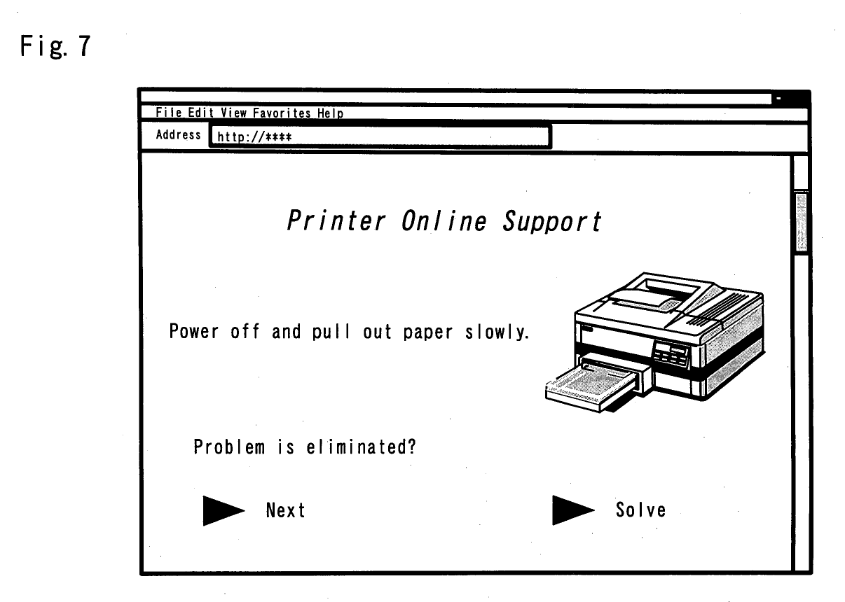

The interactive transmission of the support information is discussed below in one example where the problem of ‘paper jam’ arises in the printer. FIG. 7 shows an example of the support information in the form of a Web page displayed on the browser. In this Web page, the support information ‘Power off and pull out paper slowly’ is provided as Workaround 1 against the paper jam. The user tries this operation. When the problem is eliminated by this operation, the user clicks ‘Solve’. Otherwise the user clicks ‘Next’. When ‘Solve’ is clicked, the display is returned to the top page 100 as shown in FIG. 6. When ‘Next’ is clicked, on the other hand, a next possible operation is offered to the user. The user inputs the result of each operation and successively obtains support information in response to the user's requirement.

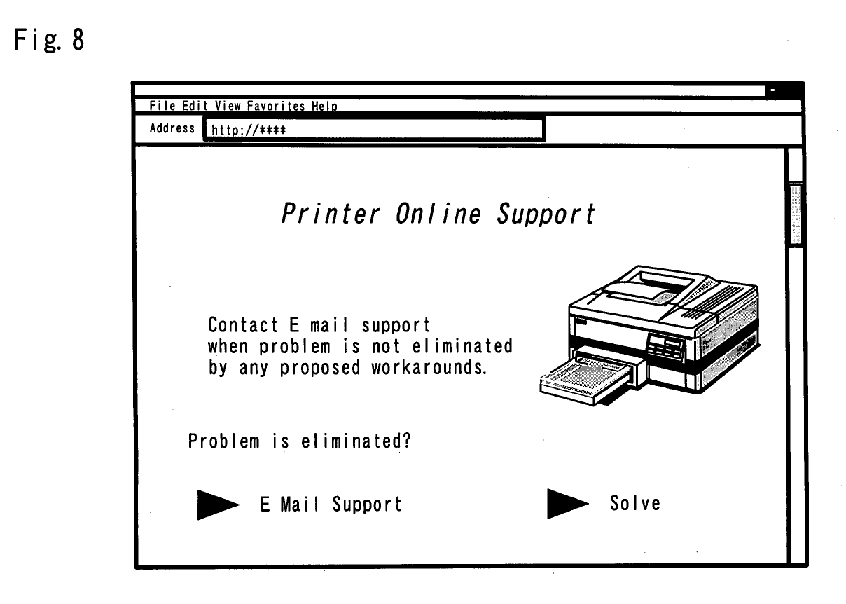

FIG. 8 shows a window display when a problem is not eliminated by any of possible operations prepared in advance as support information. As mentioned previously, the user gains E mail support in such cases. The window shows a link ‘E Mail Support’ as an option when the problem is not resolved. The user clicks the link to gain the E mail support.

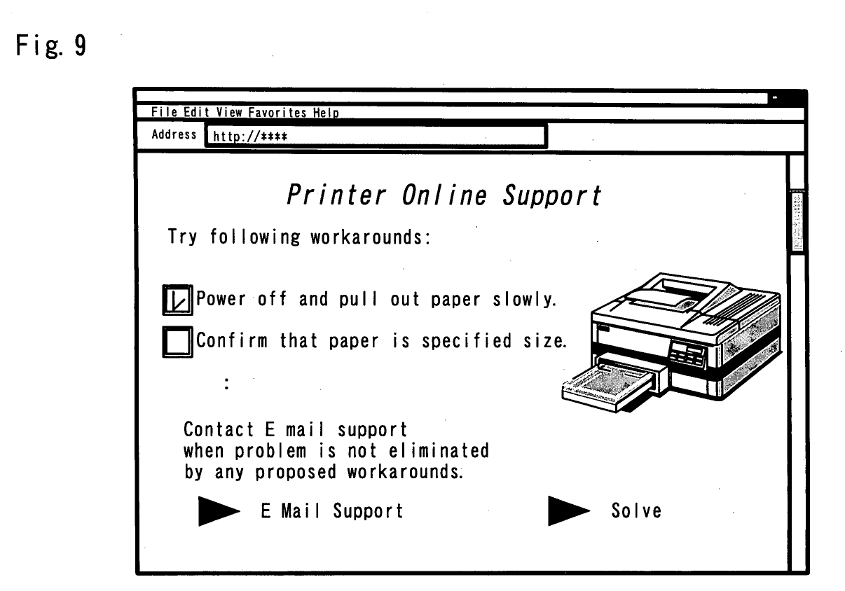

In the arrangement of the embodiment, the support information is successively provided (see FIGS. 6 and 7). The procedure of providing the support information is, however, not restricted to this application. FIG. 9 shows a window display providing the support information against the problem of paper jam as a modified example. In the modified example, the possible operations to eliminate the problem are shown collectively in the form of a list of the support information. The user ticks the checkbox corresponding to the operation that the user has tried. The checkboxes are provided for convenience of the user and may be omitted. When the problem is not eliminated by any of these possible operations, the user clicks a link ‘E Mail Support’ to gain the E mail support.

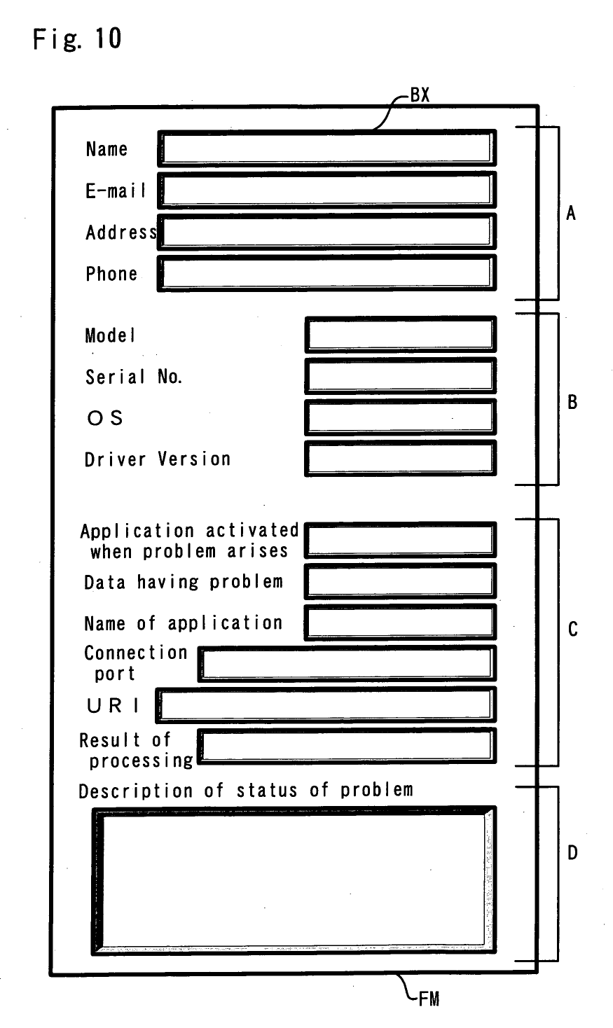

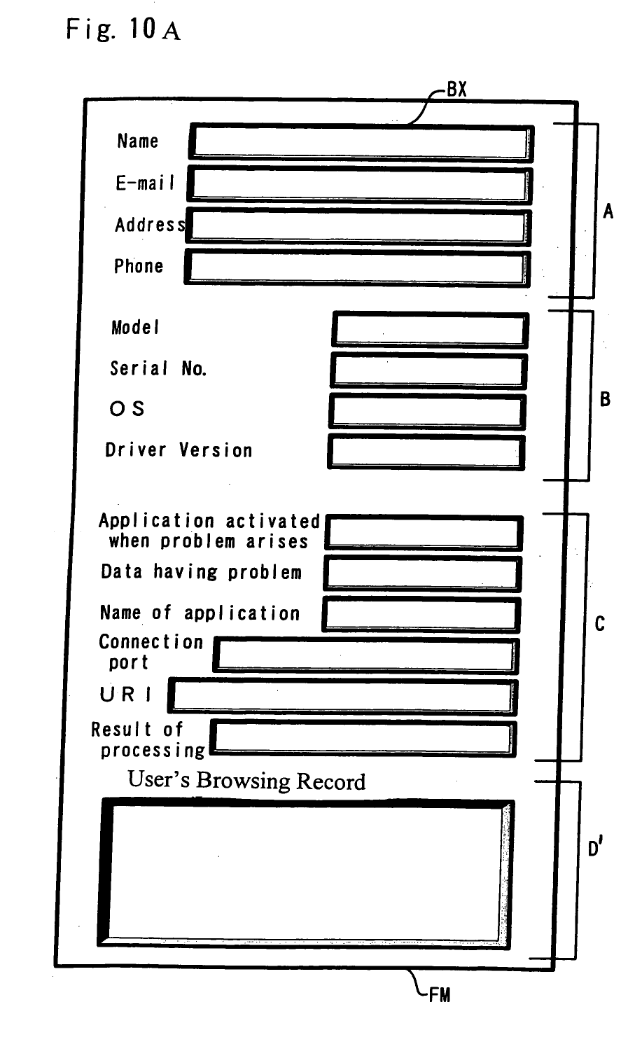

The E mail support is carried out when the user inputs required pieces of information in a predetermined transmission form and transmits the filled-in form to the support center. FIG. 10 shows a transmission form as an example. The arrangement of the embodiment displays the transmission form on the browser by means of the CGI. The user inputs required pieces of information in boxes BX of the respective items.

The transmission form includes parts A through C where the user inputs some typical pieces of information as well as a part D where the user describes the status arbitrarily. The parts A through C may be omitted if not required. But these parts A through C facilitate the input of typical information required for the E mail support. Even when there are some blanks in the parts A through C, the user gains the support to the extent that the provided information allows.

Pieces of information with regard to the user are input in the part A. In this embodiment, the part A includes the name, the E-mail address, the address, and the telephone number of the user. The support center uses these pieces of information to contact the user. A user's speaking language may be added to the part A so that the user could be contacted in his language by the support center near to his address.

Pieces of information with regard to the model of the printer having the problem are input in the part B. In this embodiment, the part B includes the model, the serial umber, the operating system, and the driver version. These pieces of information specify the basic conditions in the process of analyzing the cause of the problem.

Pieces of information for specifying the working status when the problem arises are input in the part C. In this embodiment, the part C includes the name of the application program activated in the user's computer PCu when the problem arises, the data processed at that time, and the name of the application program used for processing the data, the connection port of the printer, the URI (uniform resource indicator) of the printer, and the result of the processing by the printer when the problem arises. These pieces of information are used to analyze the cause of the problem as discussed below.

The application program activated when the problem arises represents the information regarding all the active application programs including the application program causing the problem. This information is used to estimate the marginal capacity of the memory resource in the computer PCu when the problem arises.

The data having the problem, that is, the application file, and the name of the application program used for processing the data are used to determine whether or not the problem found in the printing result is ascribed to the application program. The problem found in the printing result may be caused by abnormality of data transmitted from the application program to the printer driver 12 or by abnormality of print data generated through the processing of the printer driver 12 or an abnormal operation of the printer based on the print data. The input of the application file and the name of the application program enables the support center to investigate the application program and determine whether or not the cause of the problem is ascribed to the application program. The application file may be attached to the information input in the transmission form shown in FIG. 10 and directly transmitted. Another procedure inputs and transmits only file path information of the application file in the transmission form. In this case, the support center accesses the user's computer PCu based on the file path information and obtains the application file. The user may directly input the information with regard to the application file in the transmission form of FIG. 10. Alternatively the procedure may utilize an interface that enables input by the drag and drop of an icon representing the application file of interest.

The connection port of the printer represents the information regarding the communication environment between the computer PCu and the printer. Typical examples of the connection port of the printer include a parallel port, a serial port, a USB (universal serial bus). These pieces of information are used to specify the cause of the problem ascribed to the interface.

The support center uses the URI of the printer to access the resource in the printer. In the arrangement of the embodiment, the URI of the printer is used to gain access to the MIB in the printer. The access to the printer based on such information enables the support center to directly grasp the working status of the printer. Although the procedure of the embodiment accesses the MIB, the accessed data is not restricted to such uniformly provided data. Another application gains access to data provided specifically in the printer by means of a command specifically used in the printer.

The printing result processed by the printer in the presence of the problem represents the data with the problem most apparently appearing therein. This is accordingly effective for analysis of the cause of the problem. In the case of the printer, for example, the resulting print may be read by a scanner and transmitted to the support center. When the print data generated by the printer driver 12 is left in the computer PCu, the file of the print data may be transmitted to the support center. The user is generally not able to describe the problem sufficiently. Attachment of the printing result with the problem apparently appearing therein significantly enhances the efficiency of the analysis for the cause of the problem.

The procedure of the embodiment uses the transmission form shown in FIG. 10 for the E mail support. The transmission form may require additional items of information or, on the contrary, may exclude part of the items shown in FIG. 10.

As described above, when a problem arises in the printer, the online support system of the embodiment enables the user to gain online support and eliminate the problem. The link to the online support is provided, for example, in the setting window of the printer driver 12. This arrangement significantly improves the user's convenience for the online support.

The online support includes the self support that allows the user to browse the support information and try to eliminate the problem by the own efforts, and the E mail support utilizing the electronic mails. The user flexibly uses the appropriate support according to the circumstances. As for problems that are relatively easy to be solved, the user adopts the self support to quickly eliminate the problem. As for problems that are rather difficult to be solved, on the other hand, the user adopts the E mail support to gain the individual and concrete support for elimination of the problem.

In the arrangement of the embodiment that provides the two different types of online support, the configuration of the Web pages causes the user to try to eliminate the problem by the self support and to gain the E mail support only when the problem is not eliminated by the self support. This configuration accelerates the use of the self support. Since the subtle problems are resolved by the self support, the excessive use of the E mail support is effectively prevented. This arrangement thus desirably relieves the loading on the E mail support and enables the E mail support to concentrate on elimination of the significant problems that are not solved by the self support.

The technique of the embodiment utilizes the transmission form that includes the parts for the input of typical pieces of information to gain the E mail support. The arrangement of using such a transmission form enables the support center to obtain the pieces of information required for specifying the cause of the problem, thus offering the user the efficient resolution. The printing result processed by the printer is attached to the transmission form as the data with the problem apparently appearing therein. This further enhances the efficiency of the specification for the cause of the problem. The processed image is the most effective means to analyze the problem arising in the device that inputs or output images, such as the printer. The arrangement of the embodiment also attaches the browsing record of the self support to the transmission form. This enables the support center to estimate the operations that the user has tried to eliminate the problem and thus to narrow the range of possible causes of the problem.

FIG. 10A is another exemplary embodiment of a transmission form. In part D′, the user inputs information regarding a user's browsing record of support information.

C. Modifications

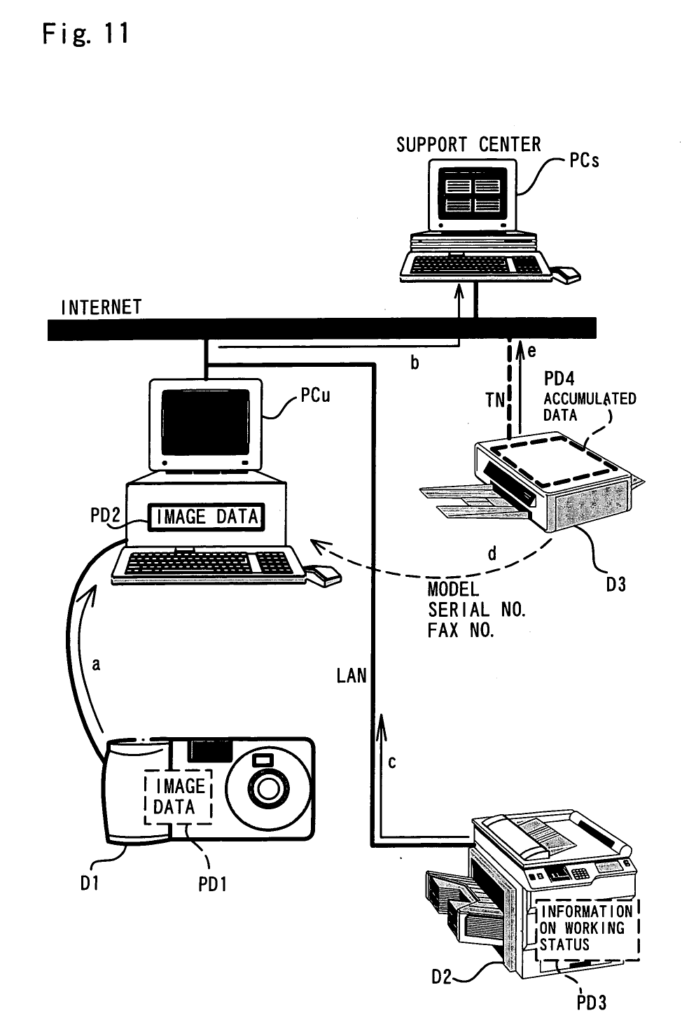

The above embodiment regards the online support that supports the normal operations of the printer. The technique of the present invention is also applicable to support normal operations of a diversity of other devices. FIG. 11 shows the configuration of another online support system in one modified example. Various devices to which the technique of the present invention are applicable are shown in the configuration of FIG. 11. These devices also input or output images. The processed image is thus most effective means to analyze the problem.

As shown in FIG. 11, the technique of the present invention is applied to support normal operations of a digital camera D1 as the device. Image data PD1 shot by the digital camera D1 may be attached as the data processed by the device for the E mail support that utilizes electronic mails. The image data PD1 is transferred to the computer PCu via a predetermined medium or via a cable connecting the digital camera D1 with the computer PCu. Image data PD2 stored in the computer PCu is then attached to the transmission form for the E mail support shown in FIG. 10 and transmitted to the support center PCs (see the arrow b in FIG. 11). In the case where the digital camera D1 is connected to the computer PCu via the cable, the address information to gain access to the digital camera D1 may be input in the transmission form of FIG. 10 and transmitted to the support center PCs. The support center PCs accesses the digital camera D1 via the computer PCu and obtains the image data PD1 stored in the digital camera D1 (see the arrows a and b).

The above embodiment regards the online support to support the operations of the printer PRT locally connected to the computer PCu. The technique of the present invention is also applicable to support the operations of devices that are connected to the computer PCu via a LAN (local area network). Such devices include those naturally using the network for operations, like the printer connected to the LAN, and those using the network for the limited purposes, for example, setting the working environment. In the configuration of FIG. 11, a copying machine D2 is shown as an example connected to the LAN of the limited use. The copying machine D2 is connected to the computer PCu via a LAN. The user specifies the various settings, for example, the magnification and the density of copy, in the computer PCu. This allows duplication in a desired mode without any complicated operations in the copying machine D2. Information PD3 regarding the working status is stored in the copying machine D2. The information PD3 of the working status may include a record of the working status and the image data read by the scanner of the copying machine as the data processed by the device. The present invention is applicable to this configuration to provide both the self support and the E mail support. It is desirable to attach the address information, which is used to gain access to the copying machine D2, to the transmission form of FIG. 10 for the E mail support. The support center PCs accesses the copying machine D2 via the Internet and the LAN based on the address information and obtains the information PD3 of the working status stored in the copying machine D2.

The above description regards the application to the devices that are connected to the computer PCu locally or via the LAN. The technique of the present invention is also applicable to a device that is not connected with the computer PCu. In the configuration of FIG. 11, a facsimile D3 is shown as such an example. The facsimile D3 is not connected with the computer PCu but is connected to a telephone network TN. The support center PCs is accordingly accessible to the facsimile D3. The facsimile D3 stores received and transmitted facsimile data therein as accumulate data D4. The present invention is applicable to this configuration to provide both the self support and the E mail support. The user inputs the model, the serial number, and the fax number of the facsimile D3 in the computer PCu and transmits these pieces of information to the support center PCs for the E mail support (see the arrow d). In the E mail support, the support center PCs transmits a command proper to the facsimile D3 via the telephone network TN and causes the facsimile D3 to send back the accumulated data PD4, which corresponds to the data processed by the device, to the support center PCs (see the arrow e). Data obtained by reading a print of the facsimile D3 with a scanner may be attached as the data processed by the device and transmitted for the E mail support.

Other devices that carry out processing of images include scanners, projectors, liquid-crystal displays, and video cameras. In the case of the scanner, it is desirable to transmit image data representing a scanned image as the data processed by the device for the E mail support. For the purpose of the comparison, image data scanned with another scanner that normally works may be attached. It is also preferable to attach the scanned image data of a certain original, which the manufacturer certainly possesses, for example, a predetermined page in the manufacture's instruction manuals. In the case of the display units, such as the projector and the liquid-crystal display, data representing the actual display status, which is shot with a digital camera, may be transmitted for the E mail support as the data processed by the device. In such cases, it is desirable to attach image data to be displayed. In the case of the video camera, compressed data obtained by compressing motion pictures or still pictures shot with the video camera in a predetermined format like MPEG are transmitted for the E mail support as the data processed by the device. For the purpose of the comparison, it is desirable to attach a video image shot with another video camera that works normally. It is also preferable to attach the shot image data of a certain original, which the manufacturer certainly possesses.

Application of the present invention is not restricted to the devices that input or output image data. For example, the technique of the present invention is applicable to data of cellular phones, MP3 players that process music and audio data, and headphone stereos. In the case of any of such devices, the audio data in a predetermined format are transmitted for the E mail support as the data processed by the device.

As discussed above, the technique of the present invention is applicable to a diversity of devices including those discussed above. In order to use the data processed by the device for the E mail support, it is preferable that the device is connected to the computer or the Internet. But the application of the present invention is not restricted to such devices connectable with the computer or the Internet. For example, the technique of the present invention is applicable to copying machines that are not connectable with the LAN. The arrangement of the present invention is sufficiently applied for the online support of such copying machines although the data processed by the copying machine are not attachable. Another procedure causes both an original and a duplicated print by the copying machine to be read with a scanner and attaches the scanned data for the E mail support.

In the above embodiment, the support center is the manufacturer of the device and provides the online support via the Internet. The technique of the present invention is also applicable to the online support that is provided via an Intranet, for example, in one organization, corporation, or enterprise. A network management section of the enterprise provides the users of certain devices in the enterprise with the online support via the Intranet to support the operations of the devices. This online support system is readily attained by simply replacing the Internet with the Intranet in the configuration of the embodiment. The configuration of the network does not always require the wired connection but may partly use wireless connection.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The scope and spirit of the present invention are indicated by the appended claims, rather than by the foregoing description.

1: An online support method that gives online support to eliminate a problem arising in a device, said online support method comprising the steps of:
(a) providing a user of the device with a specific form that enables the user to input and transmit information with regard to the problem;
(b) providing the user of the device with support information, which is prepared in advance for elimination of the problem, prior to said step (a); and
(c) obtaining browsing record information, which represents a user's browsing record of the support information, in addition to the information input in the specific form.

2: An online support method in accordance with claim 1, wherein said step (b) provides the support information in response to each selecting instruction given by the user.

3: An online support method in accordance with claim 1, wherein the specific form also asks the user to input information regarding the individual user.

4: An online support method in accordance with claim 1, wherein the specific form also asks the user to input information regarding an operation carried out by the user to eliminate the problem.

5: An online support method in accordance with claim 1, wherein the specific form asks the user to input information regarding a user's browsing record of the support information provided in advance.

6: An online support method in accordance with claim 1, wherein the specific form comprises a first part that asks the user to input specific information, which is generally required for analysis of the problem, and a second part that enables the user to input arbitrary information with regard to the problem.

7: An online support method in accordance with claim 6, wherein the information includes first information required to identify the device and second information required to specify a working status of the device.

8: An online support method in accordance with claim 7, wherein the first information required to identify the device includes at least one of a model name of the device, an ID number allocated to the individual device, information that identifies a driver program for driving the device, and information that identifies an operating system on which the driver program runs.

9: An online support method in accordance with claim 7, wherein the second information required to specify the working status of the device includes at least one of information that identifies an application program activated on the device when the problem arises, information that identifies an application program used for driving the device and specifies data transmitted to the device, and information that specifies a communication environment of the device.

10: An online support method in accordance with claim 7, wherein the device comprises a storage unit in which specific information representing the working status of the device is stored, and the second information required to specify the working status of the device comprises information that allows an access to the storage unit.

11: An online support method in accordance with claim 6, wherein the specific form also asks the user to input information regarding the individual user.

12: An online support method in accordance with claim 6, wherein the specific form also asks the user to input information regarding an operation carried out by the user to eliminate the problem.

13: An online support method in accordance with claim 6, wherein the specific form asks the user to input information regarding a user's browsing record of the support information provided in advance.

14: An online support method in accordance with claim 1, wherein said step (a) enables the specific form to be offered to the user without said step (b), in response to an instruction given by the user.

15: An online support method that gives online support to eliminate a problem arising in a device, said online support method comprising the step of:
providing a user of the device with a specific form that enables the user to input and transmit information with regard to the problem, wherein the specific form comprises a first part that asks the user to input specific information, which is generally required for analysis of the problem, and a second part that enables the user to input arbitrary information with regard to the problem.

16: An online support method in accordance with claim 15, wherein the information includes first information required to identify the device and second information required to specify a working status of the device.

17: An online support method in accordance with claim 16, wherein the first information required to identify the device includes at least one of a model name of the device, an ID number allocated to the individual device, information that identifies a driver program for driving the device, and information that identifies an operating system on which the driver program runs.

18: An online support method in accordance with claim 16, wherein the second information required to specify the working status of the device includes at least one of information that identifies an application program activated on the device when the problem arises, information that identifies an application program used for driving the device and specifies data transmitted to the device, and information that specifies a communication environment of the device.

19: An online support method in accordance with claim 16, wherein the device comprises a storage unit in which specific information representing the working status of the device is stored, and the second information required to specify the working status of the device comprises information that allows an access to the storage unit.

20. An online support method in accordance with claim 15, wherein the specific form also asks the user to input information regarding the individual user.

21: An online support method in accordance with claim 15, wherein the specific form also asks the user to input information regarding an operation carried out by the user to eliminate the problem.

22: An online support method in accordance with claim 15, wherein the specific form asks the user to input information regarding a user's browsing record of the support information provided in advance.

23: An online support method in accordance with claim 15, wherein the device carries out one of processing and generation of digital data, and the specific form asks the user to input at least information that is required to specify a result of either of the processing and the generation carried out by the device.

24: An online support method in accordance with claim 23, wherein the device inputs one of image data and audio data, and the information is one of the image data and the audio data input into the device.

25: An online support method in accordance with claim 23, wherein the device outputs one of an image and audio based on digital data, and the information represents electronic data representing one of the image and the audio output by the device.

26: An online support method in accordance with claim 1, wherein the information includes first information required to identify the device and second information required to specify a working status of the device.

27: An online support method in accordance with claim 26, wherein the first information required to identify the device includes at least one of a model name of the device, an ID number allocated to the individual device, information that identifies a driver program for driving the device, and information that identifies an operating system on which the driver program runs.

28: An online support method in accordance with claim 26, wherein the second information required to specify the working status of the device includes at least one of information that identifies an application program activated on the device when the problem arises, information that identifies an application program used for driving the device and specifies data transmitted to the device, and information that specifies a communication environment of the device.

29: An online support method in accordance with claim 26, wherein the device comprises a storage unit in which specific information representing the working status of the device is stored, and the second information required to specify the working status of the device comprises information that allows an access to the storage unit.

30: An online support method in accordance with claim 26, wherein the specific form also asks the user to input information regarding the individual user.

31: An online support system that gives information to a client and thereby carries out online support to eliminate a problem arising in a device of the client, said online support system comprising:
a transmission form providing unit that provides the client with a specific form that enables the client to input and transmit information with regard to the problem; and
a link providing unit that provides the client with a link to said transmission form display unit in a predetermined page that allows an access to support information prepared in advance for elimination of the problem; and
a browsing record information obtaining unit configured to obtain the browsing record information from the client in addition to the information input in the specific form, wherein the browsing record information represents a user's browsing record of the support information.

32: An online support system that gives information to a client and thereby carries out online support to eliminate a problem arising in a device of the client, said online support system comprising:
a transmission form providing unit that provides the client with a specific form that enables the client to input and transmit information with regard to the problem, wherein the specific form comprises a first part that asks the client to input specific information, which is generally required for analysis of the problem, and a second part that enables the client to input arbitrary information with regard to the problem.

33: A client that gains online support from a predetermined support server to eliminate a problem arising in a device of the client, said client comprising:
a support information display unit that receives support information, which is prepared in advance, from the predetermined support server and displays the input support information;
a browsing information registration unit that registers a browsing record of the support information as browsing information; and
a transmission unit that transmits data required for a further support, which comprises arbitrary information with regard to the problem and the browsing information, to the predetermined support server.

34: A client that gains online support from a predetermined support server to eliminate a problem arising in a device of the client, said client comprising:
a processed result storage unit that stores processed result information, which is required to specify a result of either of processing and generation carried out by the device; and
a transmission unit that transmits data required for a further support, which comprises arbitrary information with regard to the problem and the processed result information, to the predetermined support server.

35: A client in accordance with claim 34, wherein the device inputs either of image data and audio data, and the processed result information is either of the image data and the audio data input into the device.

36: A client in accordance with claim 34, wherein the device outputs either of an image and audio based on digital data, and the processed result information is electronic data representing either of the image and the audio output by the device.

37: A recording medium in which a program is recorded, wherein said program functions to drive a device and causes a link to an upper-layered online support Web page, which does not depend upon a model of the device nor a problem, out of support Web pages that provide a client with support information to eliminate a problem arising in the device to be shown in at least one of a setting window that allows a user of the device to specify settings of the device and a display window that displays a working status of the device.
